(19) United States
(12) Patent Application Publication
(10) Pub. No.: US 2006/0287089 A1
(43) Pub. Date: Dec. 21, 2006

(54) System and method for interfacing a simulation device with a gaming device

(76) Inventors: David Ralph Addington, Lake Elsinore, CA (US); Xuejun Tan, Riverside, CA (US); Amro Albanna, Riverside, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/433,066

(22) Filed: May 12, 2006

Related U.S. Application Data
(60) Provisional application No. 60/681,112, filed on May 13, 2005.
(60) Provisional application No. 60/771,963, filed on Feb. 9, 2006.

(51) Int. Cl. A63F 13/00

(52) U.S. Cl. 463/37

(57) ABSTRACT

A system and method for interfacing a simulation device with a gaming device is disclosed. The system comprises a video game controller and a sensor. The controller is configured to mimic certain aspects of standard game controllers, providing control functions to a video game, with added functionality to accept input of an external control signal. The game controller is further configured to allow one or more of its control functions to be overridden by control functions provided by the external control signal. The sensor measures simulation parameters representative of actions performed on the simulation device and outputs simulation control signals representative of the simulation parameters. The sensor simulation control signals may be input to the game controller to provide control functions to the video game using both the simulation device and the game controller.

### CROSS-REFERENCE TO RELATED APPLICATIONS

This application claims the benefit of priority under 35 U.S.C. §119(e) of U.S. Provisional Application No. 60/681,112, filed on May 13, 2005 and entitled SYSTEM AND METHOD FOR INTERFACING FITNESS DEVICE WITH GAMING DEVICE and U.S. Provisional Application No. 60/771,963, filed on Feb. 9, 2006 and entitled SIMULATION DEVICE FOR BOARDING SPORT GAMES, the entirety of which are incorporated herein by reference.

### BACKGROUND OF THE INVENTION

1. Field of the Invention

This invention relates generally to video game control systems and, in particular, to systems and methods for interfacing a simulation device to a video game device, so to allow the simulation device to control one or more functions of the video game.

2. Description of the Related Art

Video games are a widely popular source of entertainment. According to some estimates, nearly one half of all U.S. households own a video game console or a personal computer by which video games can be played. Video games are available in a wide variety of genres, including role playing games, driving simulations, and sports, providing a source of relaxation and immersion for users of many interests. Increasingly, though, video game users are seeking greater levels of immersion and activity in their game play.

To meet this need, systems have been developed which allow a user to simulate an activity and measure some portion of that activity to control a video game played on a video game player. In one example, U.S. Pat. No. 5,362,069 to Hall-Tipping (“Hall-Tipping”) describes an apparatus usable with an exercise device, such as an exercise bicycle, and a video game player. The apparatus utilizes a sensor built into the bicycle to sense an output level of the bicycle, such as pedal speed, and generate an output level signal indicative of the user's pedal speed. A joystick controller may also be utilized to generate signals to control the play of the game. The signals are transmitted to a processor by an interface and combined into signals which are output to the video game player to control operations of the video game.

The design of the Hall-Tipping device presents numerous disadvantages for a user, however. Notably, the Hall-Tipping device employs an interface which receives a number of cables to allow communication between the exercise bicycle, the joystick and the video game player. The proper configuration of these cables may be difficult for a user, particularly younger users or technically unsophisticated adults, to set up. Furthermore, the large number of communication cables utilized by the interface increases the likelihood of one or more cables becoming detached from the video game player, disrupting control of the game. Additionally, should the interface become lost or broken, the bicycle may not be used in conjunction with the video game. All of these disadvantages may frustrate the user and diminish their enjoyment of games played on the video game player.

In further disadvantage, the Hall-Tipping device allows both the joystick controller and the output of the exercise bike to control the same functions of the game. So configured, users of the apparatus may inadvertently control one or more functions of the game with the joystick when meaning to provide control functions through the exercise device or vice versa. This configuration may therefore interfere with game play also diminish a user's enjoyment of games played on the video game player.

An additional disadvantage of the Hall-Tipping device is the configuration of the sensor. The sensor is built into the exercise device, preventing a user from employing the apparatus with any other exercise device. Therefore, if the exercise device breaks or the user wishes to use a different exercise device in conjunction with the apparatus, the user must purchase a new apparatus and exercise device at significant expense.

In another example, U.S. Pat. No. 6,543,769 to Podoloff, et al (“Podoloff”), describes a snowboard apparatus connectable to a video game player. The apparatus allows a user to perform snowboarding maneuvers and output a signal representative of the snowboard position to an interface circuit connected to the video game player in order to control the play of the video game. A non-standard auxiliary hand controller may also be input into the interface circuit to provide further control functions for additional maneuvers.

The Podoloff device also provides an unsatisfying control configuration for a user. In one disadvantage, the Podoloff device, similar to the Hall-Tipping device, also utilizes an interface to allow communication between the snowboard apparatus, the hand controller, and the video game player, with the attendant disadvantages discussed above. Furthermore, the shape and the position of the controls in the non-standard controller differ significantly from a standard hand controller. Therefore, a user of the apparatus familiar with standard hand controllers must learn to use the new controller. This learning process can be a frustrating and time consuming process which may diminish a user's enjoyment of the game.

These deficiencies in current video game interface designs illustrate the need for improved methods and systems for interfacing a video game with a simulation device which are easy to use and reduce the potential for user error.

### SUMMARY OF THE INVENTION

In one aspect, the preferred embodiments of the present invention provide a system for interfacing an exercise device with a gaming device capable of playing video games. The system comprises at least one sensor positioned adjacent to a moving portion of the exercise device, where the at least one sensor measures at least one motion parameter of the exercise device and generates at least one simulation control signal providing a first plurality of control functions for the gaming device representative of the at least one motion parameter. The system further comprises at least one video game controller housing a plurality of user-actuated controls capable of single- and multi-dimensional actuation, where actuation of the controls by a user provides a second plurality of control functions for the gaming device and where the video game controller communicates with the at least one sensor to receive the at least one simulation control signal. The at least one video game controller also outputs a third plurality of control functions for the gaming device comprising at least one of the first and second plurality of control functions.

In another aspect, the preferred embodiments of the present invention provide a system for interfacing a simulation device with a gaming device capable of playing a video game. The system comprises a simulation device which allows a user to perform a plurality of movements simulating a physical activity. The system also comprises at least one sensor positioned adjacent to a moving portion of the simulation device, where the at least one sensor measures at least one motion parameter of the exercise device and generates at least one simulation control signal providing a first plurality of control functions for the gaming device representative of the at least one motion parameter. The system further comprises at least one video game controller housing a plurality of controls capable of single- and multi-dimensional actuation, where user actuation of the controls provides a second plurality of control functions for the gaming device and where the video game controller receives the at least one simulation control signal.

In another aspect, the preferred embodiments of the present invention provide a system for interfacing a simulation device with a gaming device capable of playing video games. The system comprises at least one sensor which measures at least one simulation parameter of the simulation device and generates at least one simulation control signal providing a first plurality of control functions for the gaming device representative of the at least one simulation parameter. The system further comprises at least one video game controller housing a plurality of controls capable of single- and multi-dimensional actuation, where actuation of the controls by a user provides a second plurality of control functions for the gaming device, and where the at least one video game controller receives the first plurality of control functions from the sensor. Additionally, the at least one video game controller overrides at least one of the second plurality of control functions with at least one of the first plurality of control functions and outputs a third plurality of control functions comprising at least one of the control functions of the first and second plurality of control functions.

In another aspect, the preferred embodiments of the present invention provide a video game controller for use with a gaming device capable of playing a video game. The system comprises a body dimensioned to be held in the hands of a user of the video game controller. The system further comprises a plurality of user-actuated controls, where actuation of the controls provides a first plurality of control functions for the gaming device, and where the video game controller is capable of receiving an external control signal which provides a second plurality of control functions for the gaming device. The video game controller outputs a third plurality of control functions for the gaming device comprising at least one of the first and second plurality of control functions.

In another aspect, the preferred embodiments of the present invention provide a system for interfacing an exercise bicycle having a rotating portion with a gaming device capable of playing a video game. The system comprises at least one sensor in communication with the rotating portion of the bicycle, comprising a generally circular rotatable member segmented into two substantially mating sections which may be reversibly separated to secure the rotatable member to a mounting location on the exercise bicycle at the aperture, where contact of the rotatable member with at least a portion of the rotating portion of the bicycle transfers rotational motion from the rotating portion to the rotatable member and a sensing element positioned substantially adjacent to the rotatable member which measures the rotational motion of the rotatable member, where the sensor generates at least one simulation control signal providing a first plurality of control functions for the gaming device representative of the at least one rotational parameter. The system further comprises at least one video game controller housing a plurality of user-actuated controls capable of single- and multi-dimensional actuation, where actuation of the controls by a user provides a second plurality of control functions for the gaming device and where the video game controller communicates with the at least one sensor to receive the at least one simulation control signal. The at least one video game controller outputs a third plurality of control functions for the gaming device comprising at least one of the first and second plurality of control functions.

In another aspect, the preferred embodiments of the present invention provide a boarding-sport simulation device. The device comprises a board, a base that supports the board, where the base allows movement of the board resulting from one or more boarding maneuvers performed by a player using the gaming device, at least one sensor which measures at least one motion parameter of the board and generates at least one simulation control signal providing a first plurality of control functions for the gaming device representative of the movement of the board, and at least one video game controller which houses a plurality of controls, where actuation of the controls by a user provides a second plurality of control functions for the gaming device, and where the at least one video game controller receives the at least one simulation control signal from the at least one sensor.

In another aspect, the preferred embodiments of the present invention provide a method of interfacing a simulation device with a gaming device capable of playing video games. The method comprises sensing at least one simulation parameter, generating at least one simulation control signal representative of the at least one simulation parameter which provides a first plurality of control functions for the gaming device, communicating the at least one simulation control signal to a video game controller housing a plurality of user-actuated controls whose actuation provides a second plurality of control functions for the gaming device, overriding at least one of the second plurality of control functions with at least one of the first plurality of control functions, and providing a third plurality of control functions to the gaming device comprising at least one of the first and second pluralities of control functions.

In another aspect, the preferred embodiments of the present invention provide a sensing component for measuring movement of a structure. The system comprises a rotatable member comprising a disk possessing a through aperture, a first wall extending outward from the plane of the disk at approximately the periphery of the disk, and a second wall extending outward from the plane of the disk at approximately the periphery of the aperture, where the rotatable member is segmented into two substantially mating sections and where the sections may be reversibly separated in order to secure the rotatable member to a mounting location at the aperture. The sensing component also comprises a pattern positioned on the rotatable member, comprising at least two distinguishable regions. The sensing component further comprises a sensing element position adjacent to the pattern, capable of distinguishing between the at least two regions of the pattern. The sensing component additionally comprises a coupling which interconnects the rotatable member and the sensing element so as to allow the rotatable member to rotate with respect to the sensing element. Contact of at least a portion of the rotatable member with the moving structure causes the rotatable member to rotate and where the sensing element senses the motion of the pattern on the rotatable member and outputs a sensing component signal representative of the rotational motion of the rotatable member.

### BRIEF DESCRIPTION OF THE DRAWINGS

FIG. 1 is a block diagram of a video game interface system for interfacing a simulation device with a gaming device of a preferred embodiment of the present invention;

FIGS. 2A-2C present embodiments of a video game controller of the system of FIG. 1;

FIGS. 3A-3F are schematic illustrations of one embodiment of a method for overriding at least one control function provided by the game controller of FIG. 2;

FIG. 4 is a schematic illustration of one embodiment of a sensor of the system of FIG. 1;

FIG. 5 is one embodiment of a the system of FIG. 1 utilized with an exercise device;

FIGS. 6A-6B present one embodiment of a sensing component of the system of FIG. 1 mounted to the exercise device;

FIG. 7 is one embodiment of a sensing component of the system of FIG. 1, illustrating the configuration of the sensing component for measuring rotational speed of the exercise device;

FIG. 8 is one embodiment of a gaming situation utilizing the interface system of FIG. 1 with a boarding-sport simulation device;

FIG. 9 is one embodiment of the boarding-sport simulation device;

FIGS. 10A-10C are embodiments of different configurations of a tilt sensor assembly of the system of FIG. 1 for use in measuring the motion of the boarding-sport simulation device;

FIGS. 11A-11D are embodiments of configurations pedestals of the boarding-sport simulation device of FIG. 9;

FIGS. 12A-12D are further embodiments of configurations pedestals of the boarding-sport simulation device of FIG. 9;

FIG. 13 is one embodiment of a coordinate system, illustrating two dimensions in which tilt may be measured by a tilt sensor assembly of the system of FIG. 1;

FIG. 14 is a schematic illustration of one embodiment of the tilt sensor assembly of the system of FIG. 1, configured to measure tilt in two dimensions;

FIG. 15 is one embodiment of a sample coordinate system, illustrating three dimensions in which tilt may be measured by the tilt sensor assembly of FIG. 1;

FIG. 16 is a schematic illustration of one embodiment of the tilt sensor assembly of the system of FIG. 1, configured to measure tilt in three dimensions;

FIG. 17 is a schematic illustration of a plurality of end-swing sensor assemblies of the system of FIG. 1, configured to measure swinging and or rotational motions of the boarding-sport simulation device;

FIGS. 18A-18C illustrate one embodiment of sensing component signals output by a transverse tilt sensor assembly of the system of FIG. 1 in response to transverse tilt of the boarding-sport simulation device;

FIG. 19 is a schematic illustration of embodiments of movements the boarding-sport simulation device of FIG. 9 which may be measured by configurations of the tilt sensor assembly; and

FIGS. 20A-20E are embodiments of the boarding-sport simulation device of FIG. 9 configured to simulate skiing.

### DETAILED DESCRIPTION OF THE PREFERRED EMBODIMENT

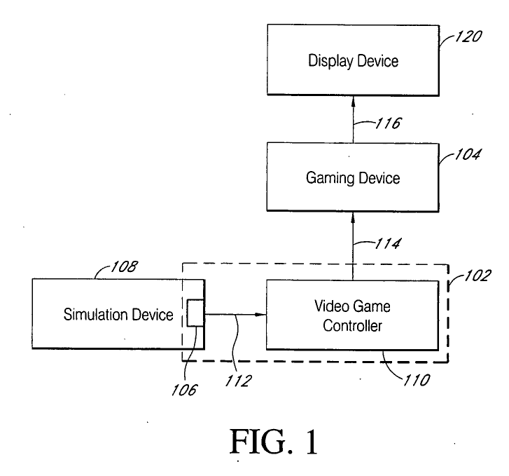

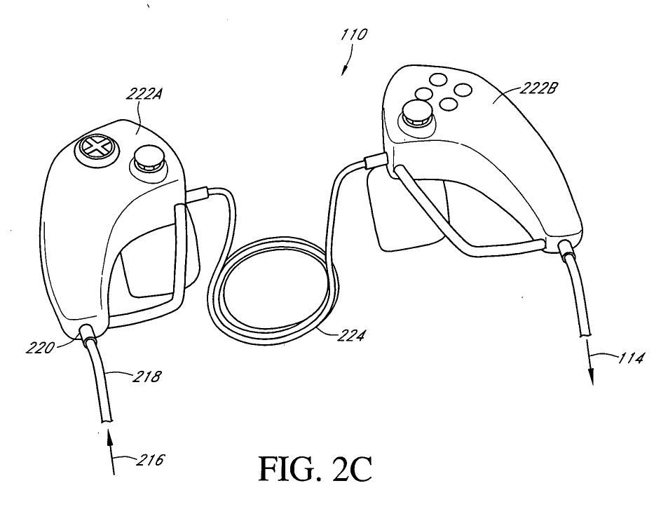

FIG. 1 presents a block diagram of one embodiment of a gaming device interface system 102 for use in interfacing a simulation device 108 to a gaming device 104. As shown in FIG. 1, the interface system 102 comprises a sensor 106 and video game controller 110. In general, the video game controller 110 is configured to provide control functions for a game played on the gaming device 104 such as speed or directional movement. The sensor 106 is configured to measure one or more simulation parameters of the simulation device 108, for example, the pedaling speed of an exercise bike, and output a simulation control signal 112 which is representative of the measured simulation parameters to the video game controller 110. Using the sensor 106 in conjunction with the video game controller 110, the video game controller 110 receives the simulation control signal 112 and communicates a controller output signal 114 to the gaming device 104. This design allows the interface system 102 to provide control functions for the gaming device 104 that may include control functions provided by the simulation control signal 112, as well as the video game controller 110. In one embodiment, discussed in greater detail below with respect to FIGS. 3A-F and 4A-4D, the simulation control signal 112 may override one or more control functions of the video game controller 110. Advantageously, this design allows games played on the gaming device 104 to be simultaneously controlled using both the simulation device 108 and the video game controller 110, without the control functions provided by the sensor 106 and the video game controller 100 interfering with each other.

As illustrated in FIG. 1, the gaming device 104 is further configured to an provide an audio/visual output signal 116 to an display device 120 such as a monitor or television unit. As generally known, such visual display and accompanying sound can provide an entertaining simulation.

In one embodiment, the interface system 102 can provide control functions for a variety of electronic games and gaming devices 104. In certain embodiments, the gaming device 104 may comprise personal computers. In alternative embodiments, the gaming device 104 may comprise dedicated electronic devices designed to play video games, also known as video game consoles. Examples of such video game consoles may include the Microsoft XBox™ and Xbox 360™, the Sony Playstation™, Playstation 2™, and Playstation 3™, and the Nintendo Entertainment System™, Super Nintendo™, Nintendo 64™, and Nintendo GameCube™. Non-limiting examples of electronic games for which the interface system 102 may provide control functions include exercise, racing, and action video games. Based on the configuration of the simulation device 108 employed, the interface system 102 may provide control functions based on simulation parameters which may include, but are not limited to, a user's speed or pace of running, walking, or biking or motions and maneuvers performed by the user during motoring, skiing, snowboarding, and skateboarding. Embodiments of the interface system 102 employing example simulation devices 108 are discussed in greater detail below in Examples 1 and 2.

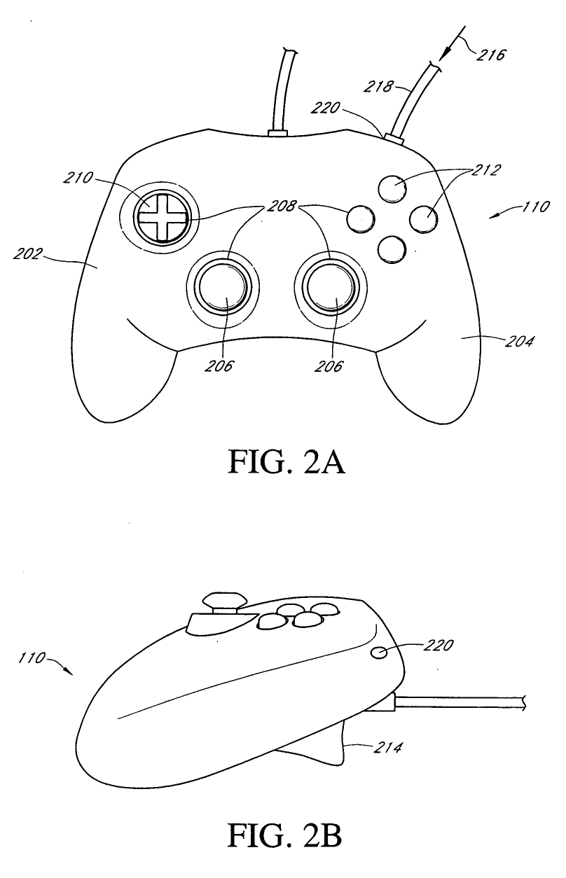

FIGS. 2A-2B present front and side views of one embodiment of the video game controller 110. In one embodiment, the game controller 110 possesses a body 202 with integrated handles 204, allowing a user to grasp the game controller 110 during use. Mounted on the body 202 are controls which may include, but are not limited to, thumbsticks 206, directional pads 210, buttons 212, and triggers 214. These controls are positioned on the body 202 within easy reach of the user's fingers and thumbs for use when grasping the controller 110. So positioned, these controls may be actuated in one or more dimensions. For example, one-dimensional actuation may include depressing the button 212 or squeezing the trigger 214, while multi-dimension actuation may include moving one or more of the thumbsticks 206 or directional pad 210 in a combination of up, down, left, or right movements.

The game controller 110 communicates with the gaming device 104 using generally understood electrical standards and software protocols to yield one or more control functions to the gaming device 104 based on actuation of the controls. The control functions (provided by each control of the game controller 110 will depend on the type of game being played. For example, the thumbsticks 206 and directional pads 210 may provide control functions such as panning and moving, as they may be actuated in multiple dimensions, while the buttons 212 and triggers 214 may provide control functions such as jumping and braking, as they may be actuated in a single dimension. For example, in a racing game, the thumbsticks 206 and triggers 214 may provide control functions for turning and speed, respectively, while the buttons 212 may provide control functions for braking and the horn.

In one embodiment, the game controller 110 is configured to mimic a standard game controller. As described herein, a standard game controller may comprise video game controllers manufactured for video game consoles such as the Microsoft XBox and Xbox 360, the Sony Playstation, Playstation 2, and Playstation 3, or the Nintendo Entertainment System, Super Nintendo, Nintendo 64, or Nintendo GameCube, or personal computers. For example, the shape, layout of controls 208, and the relationship between controls 208 and control functions of the game controller 110 may generally similar to standard game controllers. Advantageously, this design allows a user of the interface system 102 to employ proficiency they possess in operating standard video game controllers without additional training, enhancing the user's enjoyment when using the interface system 102.

In certain embodiments, the game controller 110 may be further configured to accept an external control signal 216. In one embodiment, the game controller 110 additionally comprises a communications port 220 in the controller body 202. The port 220 allows an external communications link 218 to be reversibly connected to the game controller 110 to provide the external control signal 216. In one embodiment, the external control signal 216 may comprise the simulation control signal 112. As described in greater detail below with respect to FIG. 3, the game controller 110 may be configured to allow the external control signal 216 to override one or more control functions of the game controller 110.

In an alternative embodiment, illustrated in FIG. 2C, the game controller 110 may comprise two bodies 222A and 222B and controls 208. The two bodies 222A and 222B are configured to communicate with each other by a controller communications link 224 in order to provide control functions equivalent to a game controller 110 with a single body 202.

In one embodiment, the signals 112, 114, 116, and 216 and the communication links 218 and 224 described above may be wire-based, wireless, or a combination thereof. The wireless functionality can be facilitated by one or more game controllers 110 being powered by a plurality of batteries.

FIGS. 3A-3D schematically illustrate the operation of one embodiment of the game controller 110 which is configured to accept the external control signal 216. In one embodiment, the external control signal 216 comprises the simulation control signal 112 from the sensor 108. In general, actuation of the controls 208 provides a plurality of control functions 300, while the simulation control signal 112, described in greater detail below, provides a plurality of control functions 300′ to the game controller 110 representative of one or more simulation parameters of the simulation device 108. As discussed in the embodiments below, the game controller 110 can be configured such that the control functions 300′ provided by the simulation control signal 112 override one or more of the control functions 300 provided by the video game controller 110.

FIG. 3A illustrates one embodiment of the operation of the game controller 110 when the simulation control signal 112 is absent. The user of the interface system 102 actuates one or more of the controls 208 of the game controller 110 when playing a game on the gaming device 104. In response, the game controller 110 outputs the least one controller output signal 114 to the gaming device 104 which provides control functions 300, for example, 300A-300D, to the game being played. In this embodiment, the game is controlled by control functions 300 arising solely from actuation of the game controller 110.

FIG. 3B illustrates one embodiment of the operation of the game controller 110 when the simulation control signal 112 is present. The user of the interface system 102 operates both the simulation device 108 and actuates one or more of the controls 208 of the game controller 110. The game controller 110 provides control functions 300A-300D, while the simulation control signal 112 provides one or more control functions 300′, for example 300D′, where 300D and 300D′ control the same function within the video game. In one embodiment, a logic circuit within the game controller 110 detects the simulation control signal 112 and overrides the control function 300D in favor of control function 300D′ (illustrated by an “X” in FIG. 3B). As a result, the game controller 110 provides the gaming device 104 with a controller output signal 114 that provides control functions 300A-300C and 300D′. In this manner, the interface system 102 provides control functions to the gaming device 104 from both the simulation device 108 and the game controller 110. FIG. 3E presents one embodiment of a circuit 304 which provides this control function override for a one-dimensional control, while FIG. 3F presents one embodiment of a circuit 306 providing this control function override for a multi-dimensional control.

In one embodiment, the user may select whether one or more of the control functions 300 of the game controller 110 are overridden by the simulation control signal 112. FIG. 3C-3D illustrates embodiments of the game controller 110 further comprising a switch 302 which allows the user to choose to whether one or more of the control functions provided by the simulation control signal 112 overrides one or more control functions 300A-300D provided by the game controller 110. As illustrated in FIG. 3C, when the switch 302 is in the “on” or engaged position, the game controller 110 allows the external control signal 216 to override one or more control functions 300A-300D of the game controller 110. Thus, when the switch 302 is engaged, the game controller 110 allows both the game controller 110 and simulation control signal 112 to provide control functions to the gaming device 104, as described above with respect to FIG. 3B. As illustrated in FIG. 3D, when the switch 302 is in the “off” or disengaged position, the game controller 110 does not allow the simulation control signal 112 to override one or more control functions 300 provided by the game controller 110. Thus, when the switch 302 is disengaged, the game controller 110 provides all control functions 300A-300D to the gaming device 104, as described above with respect to FIG. 3A.

Advantageously, this user-selectable function control override provided by the interface system 102 gives users of the interface system 102 significant flexibility when using of the simulation device 108 to provide one or more control for a game being played on the gaming device 104. For example, a user of the interface system 102 may use the game controller 110 with the switch 302 in the disengaged position until they are ready to use the simulation device 108, as the plurality of control functions 300′ provided by the simulation control signal 112 are not received by the gaming device 104 until the user engages the switch 302. Additionally, the user can selectively use the simulation device 108 as desired during play. For example, if the user becomes frustrated or tired while using the simulation device 108 to provide control functions 300′ to the game, they may disengage the switch 302 to completely control the game with the game controller 110.

In further advantage, the design of the interface system 102 promotes ease of use of the interface system 102. In other designs for interfacing a simulation device with a gaming device, a dedicated interface interconnects a game device with a simulation device and a video game controller and is only useful when using a simulation device. As a result, this dedicated interface may become misplaced in the time between use of the simulation device, as it has no other function, frustrating a user when they desire to use the simulation device. In contrast, game controller 110 of the interface system 102 may be employed independently of the simulation device 108 to provide control functions for a game played on the game device 104 as well as allowing the simulation device 108 to communicate with the gaming device 104. This dual functionality of the game controller 110 decreases the likelihood that the game controller 110 may become misplaced between uses of the simulation device 108 and allows the user to employ the simulation device 108 at any time.

The interface system 102 may be further configured to allow the user to precisely select which control functions 300′ provided by simulation device 108 override control functions 300 provided by the game controller 110. In one embodiment, the sensor 106, the game controller 110, the simulation device 108, or a combination thereof may be configured with user-adjustable switches 302 for each of the control functions 300′ provided by the simulation device 108. Thus, for example, a user of the interface system 102 employing a simulation device 108 which provides control functions 300′ for horizontal and vertical motion may elect to override the horizontal but not the vertical control functions 300 of the game controller 110. Advantageously, this design allows the user to tailor the interface system 102 according to their preferences, further enhancing their enjoyment of the interface system 102.

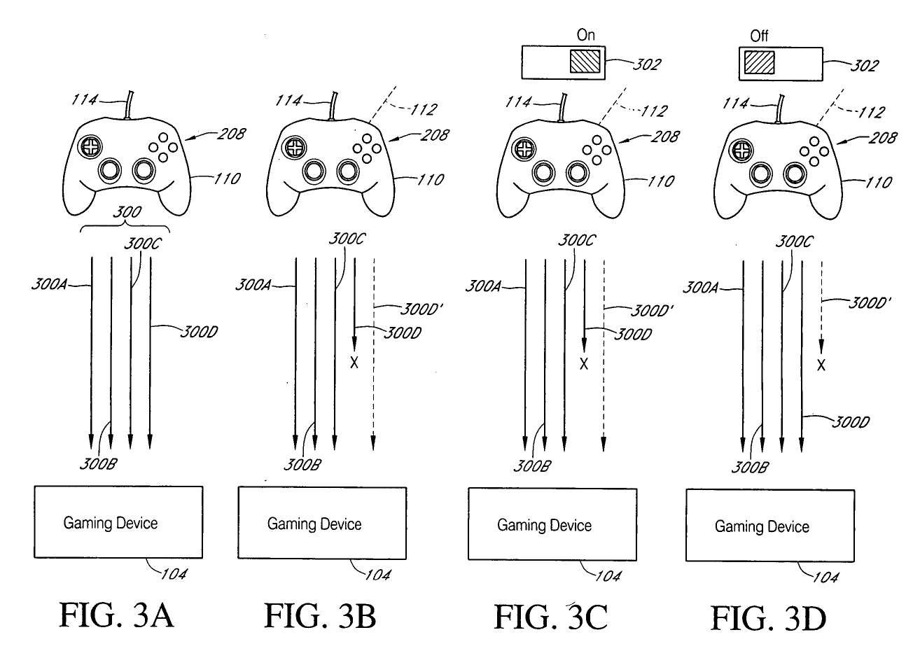

FIG. 4 illustrates a schematic illustration of one embodiment of the sensor 106. Specific embodiments of the sensor 106 will be discussed in greater detail below in Examples 1 and 2. In one embodiment, the sensor 106 comprises a sensing component 400 and a processor 402. In general, the sensing component 400 is the portion of the sensor 106 which measures one or more simulation parameters of the simulation device 108. The sensing component 400 further outputs a sensing component signal 404 representative of one or more simulation parameters to the processor 402. The processor 402 converts the sensing component signal 404 to the simulation control signal 112 which can be understood by the game controller 110 in order to provide the game controller 110 with control functions 300′ representative of the simulation parameters. It may be understood, however, that in alternative embodiments, the sensing component 400 and processor 402 may be combined in a single component.

In one specific embodiment, the processor 402 converts the sensing component signal 404 into DC voltage levels. In alternative embodiments, the sensing component 400 directly outputs sensing component signals 404 comprising DC voltage levels representative of the simulation parameters. Subsequently, these DC voltage levels can be converted by the processor 402 to equivalent three terminal resistances, commonly referred to as a potentiometers. The three terminal resistances can be input to the game controller 110 to override one or more three terminal resistors whose resistance can be varied by the user through actuation of controls 208 such as the thumbsticks 206 or triggers 214.

In a further embodiment, the user may adjust the scale of the simulation control signal 112 output to the game controller 110. For example, a user employing the interface system 102 with an exercise bicycle whose pedaling rate controls the speed of a vehicle in a racing game may begin play with a first rate of motion of the exercise bicycle 500 corresponding to a first vehicle speed in the game. As the user tires during play and their rate of pedaling slows, they may adjust the scale of the simulation control signal 112 such that the first predetermined pedal rate corresponds a second, higher vehicle speed in the game. In one embodiment, such a user-adjustable scale adjustment may be provided by a potentiometer dial which adjusts the magnitude of the simulation control signal 112 and is mounted to the interface system 102.

In general, it will be appreciated that the processor 402 can include one or more of computers, program logic, or other substrate configurations representing data and instructions, which operate as described herein. In other embodiments, the processors can include controller circuitry, processor circuitry, processors, general purpose single-chip or multi-chip microprocessors, digital signal processors, embedded microprocessors, microcontrollers and the like.

Furthermore, it will be appreciated that in one embodiment, the program logic may advantageously be implemented as one or more components. The components may advantageously be configured to execute on one or more processors. The components include, but are not limited to, software or hardware components, modules such as software modules, object-oriented software components, class components and task components, processes methods, functions, attributes, procedures, subroutines, segments of program code, drivers, firmware, microcode, circuitry, data, databases, data structures, tables, arrays, and variables.

### EXAMPLE 1

### Exercise Device Simulator

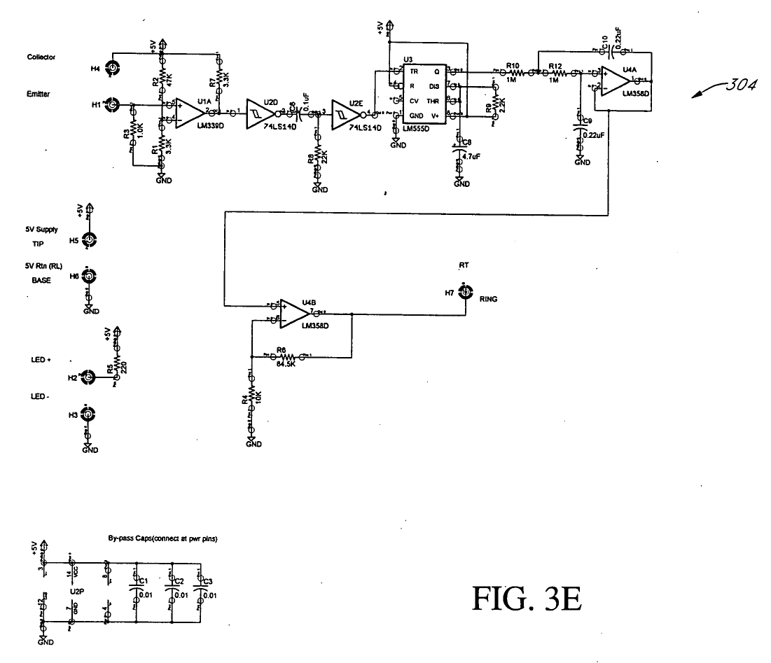

FIG. 5 illustrates one embodiment of the interface system 102 used in conjunction with an exercise device 500, for example, an exercise bicycle 500. The exercise bicycle 500 generally comprises a support base 502, a seat 504, a set of handlebars 506, and a wheel 510 joined to pedals 512 by a crankshaft 514. In general, the interface system 102 is interconnected to the exercise bicycle 500 and the gaming device 104 (not shown). So configured, the interface system 102 senses one or more simulation parameters representative of a moving portion of the exercise bicycle 500 and uses the measured simulation parameters to provide one or more control functions 300′ to a game played on the gaming device 104. As discussed above, in certain embodiments, the control functions 300′ based on the motion of the bicycle 500 may override corresponding control functions provided by the game controller 110.

In one embodiment, illustrated in FIG. 5, the game controller 110 can be reversibly mounted to the handlebars 506 of the bicycle 500. Advantageously, when so mounted, the controls 208 of the game controller 110 are within easy reach of the hands of the user while employing the exercise bicycle 500. Alternatively, the user may hold the game controller 110 in their hands while using the exercise bicycle 500.

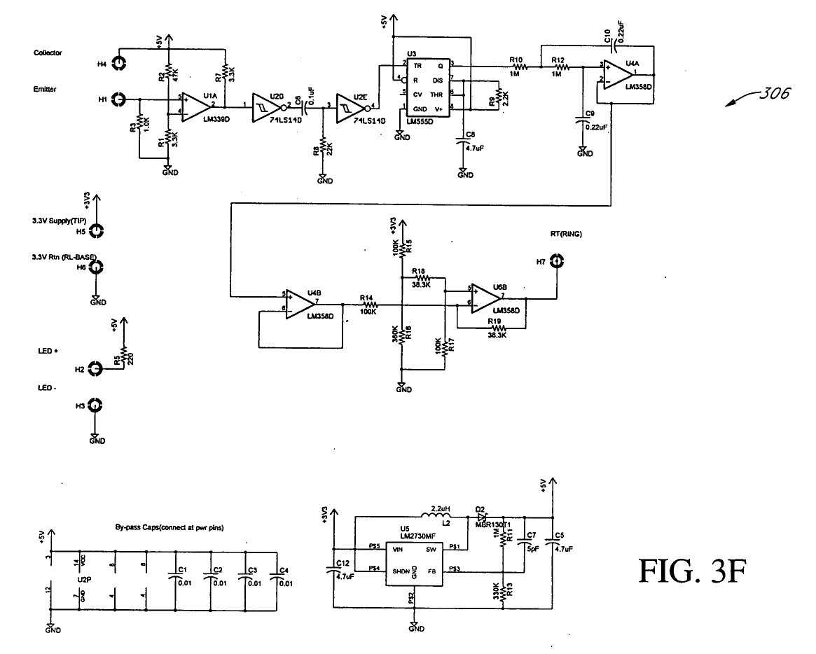

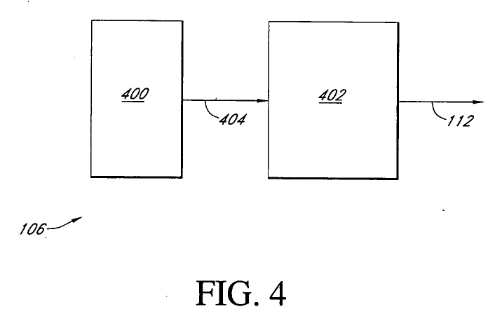

FIGS. 6A, 6B, and 7 illustrate one embodiment of the sensing component 400 mounted to the exercise bicycle 500 so as to allow transfer of motion, in a measurable manner, from the exercise bicycle 500 to the sensing component 400. As illustrated in FIG. 6A, the sensing component 400 includes a rotatable member 600. In one embodiment, the sensing component 400 is mounted to a structure 602, such as a bicycle cowling 602 at a mounting location 606, allowing the rotatable member 600 to engage a rotating part, such as the pedal crankshaft 514. Such engagement can transfer a portion of the rotational motion 610 of the pedal crankshaft 514 due to pedaling via the pedal 512, to the rotatable member 600, thereby making the rotatable member 600 rotate, as shown by arrow 612.

FIGS. 6A-6B further illustrate how embodiments of the sensing component 400 can be configured to couple with the exercise bicycle 500 so to allow rotational engagement of the rotatable member 600 with the exercise bicycle 500. In one embodiment, the rotatable member 600 includes a disk 614, an aperture 616, an outer circumferential wall 620, and an inner circumferential wall 622. The rotatable member 600 is configured to divide into two mating halves 624A and 624B which pivot with respect to one another about a hinge 626. The two halves 624A and 624B are separated to allow the aperture 616 to be positioned about the crankshaft 514. The two halves 624A and 624B are joined about the crankshaft 514 at the mounting location 606 and secured together by a reversibly locking latch 630. The sensing component 400 may further comprise a compliant layer 632 which is interconnected to the inner circumferential wall 622. This compliant layer 632, for example a foam, allows the sensing component 400 to accommodate crankshafts 514 of varying size within the aperture 616 and provide frictional engagement between the rotatable member 600 and the crankshaft 514. This frictional engagement causes the rotatable member 600 to rotate 616 when the crankshaft 514 rotates 610.

As shown in the embodiment of FIG. 7, the sensing component 400 can be configured to allow sensing of the rotational speed of the rotatable member 600. In one embodiment, an inner surface 706 of the outer circumferential walls 620 moves relative to a sensing element 700. The sensing element 700 is mounted to a mounting member 702 that is positioned at least partially within a space 704 defined by the disk 614 and the circumferential walls 620 and 622 and is substantially stationary with respect to the rotatable member 600.

The sensing element 700 can be configured to detect a rate of relative motion of the inner surface 706 of the outer circumferential wall 620 relative to the sensing element 700. In one embodiment, the sensing element 700 can comprise an optical sensor that is configured to distinguish between dark and light regions of the inner surface 706 based on reflectivity. In one embodiment, the sensing element 700 may comprise a photo reflective type optical sensor. In a preferred embodiment, the optical sensor may comprise a ROHM 800 nm reflective photointerrupter. In one embodiment, where such a sensing element 700 is used, the inner surface 706 can define an alternating pattern 710 of dark and light regions arranged along the circumference of the rotatable member 600. The inner surface 706 so configured is hereafter referred to as a sensing surface 714

In one embodiment, as illustrated in FIG. 7, the sensing element 700 can be mounted at or near an edge 712 of the mounting member 702 so as to be positioned near and radially inward from the sensing surface 714, with respect to the radius defined by rotation of the rotatable member 600. In one embodiment, the mounting member 702 may be affixed to a stationary portion of the exercise bicycle 500 such as the bicycle cowling 602 using an adhesive or other fastener. In a further embodiment, the rotatable member 600 may be rotatably coupled to the mounting member 702 via a coupling 716. Such coupling 716 can include a bearing coupling or other couplings that allow rotational movements between two parts. This configuration allows the sensing element 700 to be positioned substantially within the space 704 and substantially stationary with respect to the rotatable member 600.

In alternative embodiments, the pattern 710 and sensing element 700 may be arranged at different locations within the sensing component 400 to measure motion of the rotatable member 600. For example, the pattern 710 may be placed on the disk 614 and the sensing element 700 oriented so as to distinguish between the dark and light regions of the disk 614.

In one embodiment, a rate of movement of the sensing surface 714 can be detected by the sensing component 400 based on differences in reflectivity of the dark and light regions of the pattern 710. In one embodiment, the sensing element 700 includes an optical emitter and receiver integrated into a modular unit. The sensing element 700 can transmit radiative emissions, such as light, and detect the reflections from the sensing surface 714. Circuitry associated with the receiver can be configured to distinguish the difference between reflections from the dark regions and reflections from the light regions.

Detection of such alternating light and dark regions of the sensing surface 714 by the sensing element 700 can generate the sensing component signal 404, as illustrated in FIG. 4. In one embodiment, the sensing component signal 404 comprises an analog periodic alternating waveform. In one embodiment, the generated waveform is approximately a square wave form. In one embodiment, such waveform can be fed to the processor 402, configured with a frequency-to-voltage conversion circuit that can transform the analog signal into a relatively stable DC voltage level whose voltage level is indicative of the frequency of the analog signal frequency coming from the sensing component 400. In one embodiment, the output of frequency-to-voltage conversion circuit can fed to a low pass filter that removes high frequency components, leaving a generally constant DC voltage for a generally constant frequency. This DC voltage level can change as the rate of the rotational motion of the crankshaft 514, and thus the rotational rate of the rotatable member 600 changes. Subsequently, this DC voltage can be converted to a three-terminal resistance for input into the game controller 110 so as to provide control functions to the game controller 110, as described above.

The design of the sensing component 400 presents several advantages in use. In one advantage, the sensing component 400 may be reversibly mounted to the exercise bicycle 500. For example, the sensing component 400 is easily removed from the exemplary exercise bicycle 500 by detaching the mounting member 702 from the bicycle cowling 602, unclasping the latch 630, and separating the mating halves 624A and 624B of the disk 614. Thus, the sensor 106 may be used with multiple exercise bicycles 500. In further advantage, the sensing surface 714 and sensing element 700 are unobtrusive and generally hidden from view, as illustrated in FIG. 6A, so as not to detract from the appearance of the exercise bicycle 500.

The sensing component 400 described with respect to FIGS. 6A, 6B, and 7 can be attached to various exercise devices, including but not limited to, upright bicycles, recumbent bicycles, treadmills, stair steppers, elliptical cross-trainers, or other exercise device 500 that has as its base some form of motion inherent in one of its mechanical mechanisms. Such motion can be rotational or translational. In some exercise devices 500, such as treadmills, both rotational and translational motion can be exposed for coupling. Based on the foregoing description, the sensing component 400 can be adapted to frictionally couple to the translationally moving part, for example, the moving mat.

### EXAMPLE 2

### Boarding-Sport Simulation Device

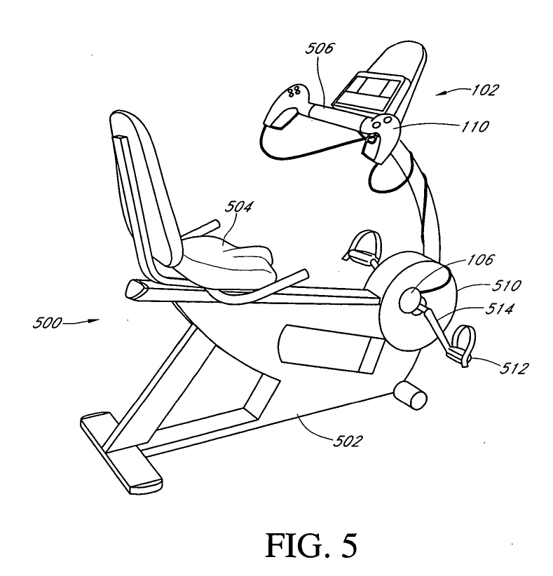

In another embodiment of the interface system 102, illustrated in FIG. 8, the interface system 102 is configured to work in conjunction with a boarding-sport simulation device 800 for simulating board-based sports such as snow-boarding, skate-boarding, skiing, and surfboarding. As is generally known, such sports involve a rider standing and balancing on a board and moving downhill on snow (in the case of snow-boarding) or rolling on pavement (in the case of skate-boarding). Various maneuvers can be achieved by applying weight on different edges or ends of the board. For example, a right turn (assuming facing forward) can be achieved by applying weight on the right edge of the board. In some embodiments of the present invention, the boarding sport simulation device 800 can be configured to allow a user to stand and balance in a manner similar to the actual riding to provide a more realistic gaming experience. While standing on the board, the user can perform various maneuvers similar to realistic situations. For example, a turn can be simulated by applying more weight on one side of the boarding-sport simulation device 800.

As shown in the embodiment of FIG. 8, the boarding-sport simulation device 800 can include a board 802 that is mounted on a pedestal 804. As described below, the pedestal 804 can be compressible under the weight of a user 806 standing on top of the board 802. Similar to a snowboard or a suspension mounted skateboard, the compressibility of the pedestal 804 can allow the user to place weight on different portions of the board 802. Such weight-placement maneuvers can be detected by the sensor 106 and the results used as the simulation device control signal to the game controller 110. In one embodiment, the interface system 102 measures various boarding maneuvers performed by a user of the boarding-sport simulation device 800 while the user simultaneously employs the game controller 110 to provide additional control functions for a boarding sport game. In some embodiments, control functions 300 of the game controller 110 may be overridden by those control functions 300′ provided by the boarding-sport simulation device 800 in the manner discussed above with respect to FIG. 3.

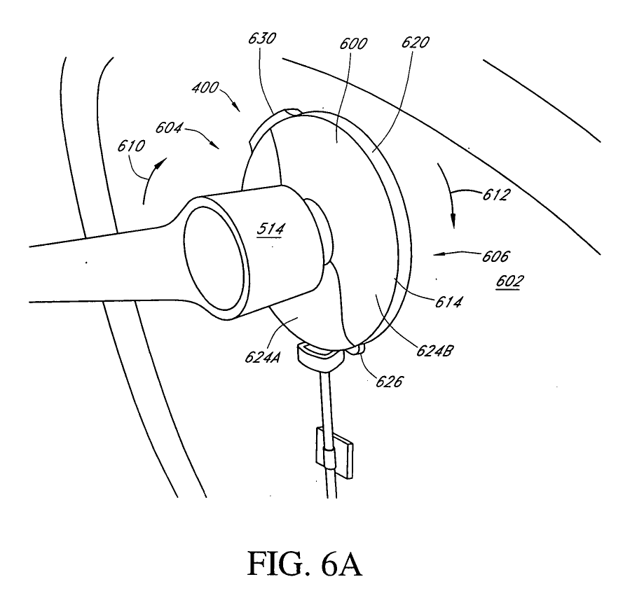

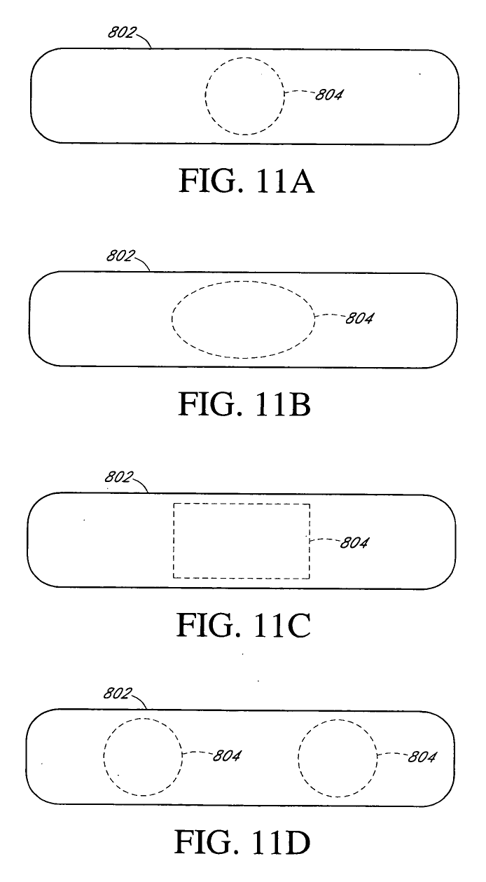

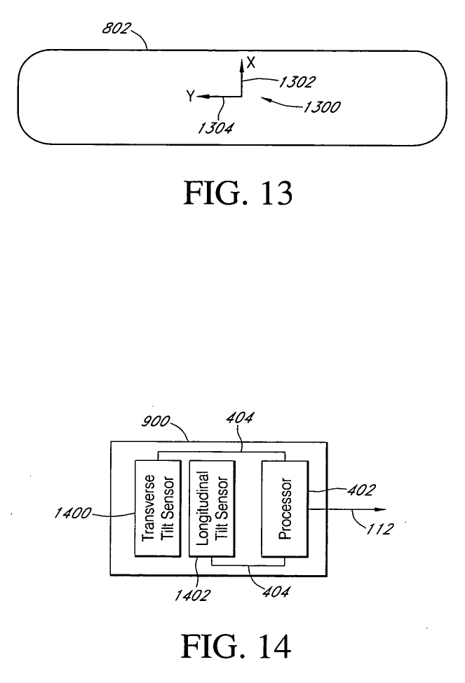

FIG. 9 shows a perspective view of one embodiment of the boarding sport simulation device 800, where the board 802 is mounted on the pedestal 804 in communication with the sensing component 400. In the embodiment of FIG. 9, the sensing component 400 comprises a tilt sensor assembly 900 in communication with the boarding sport simulation device 800 to detect boarding maneuvers, such as tilts along more than one direction. The tilt sensor assembly 900 is configured to output the simulation control signal 112 in order to provide control functions representative of boarding maneuvers performed by the user to the game controller 110. Examples of the tilt sensor assembly 900 are described below in greater detail with respect to FIGS. 14 and 16

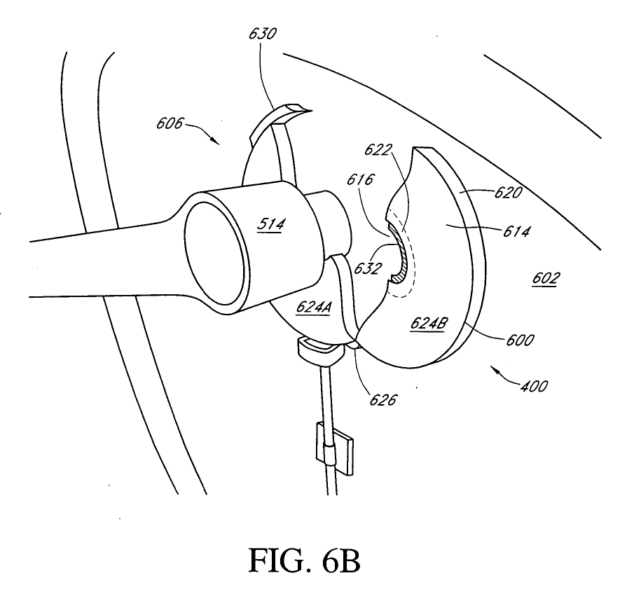

FIGS. 10A-10C illustrate embodiments of possible mounting locations for the tilt sensor assembly 900 on or about the boarding-sport simulation device 800. In one embodiment, FIG. 10A shows that the tilt sensor assembly 900 can be coupled to the underside of the board 802. A cavity 1000 can be formed on the pedestal 804 to accommodate the tilt sensor assembly 900. In one embodiment, a cable 1002 connects the tilt sensor assembly 900 to the gaming device 104. In certain embodiments, the cable 1002 may comprise a plurality of segments, for example 1002A and 1002B, which are joined by a plurality of connectors 1004. In another embodiment, illustrated in FIG. 10B, the tilt sensor assembly 900 does not need to be contained within the pedestal 804. In this embodiment, the tilt sensor assembly 900 is shown to be coupled to the underside of the board 802 but outside the pedestal 804. In a further embodiment, illustrated in FIG. 10C, the tilt sensor assembly 900 does not need to be placed under the board 802. In this embodiment, the tilt sensor assembly 900 is shown to be coupled to the upper side of the board 802. Thus, based on the foregoing embodiments, it will be appreciated that the tilt sensor assembly 900 can be positioned at many different locations on or about the board 802, as required, to measure boarding maneuvers performed using the boarding-sport simulation device 800.

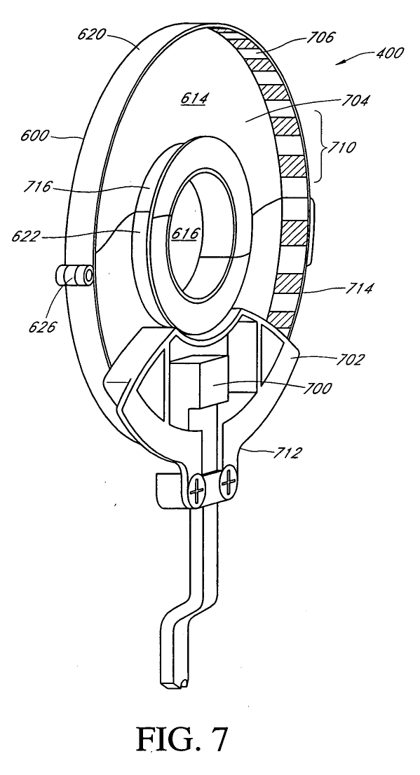

FIGS. 11A-11D illustrate different embodiments of the shape of the pedestal 804. For example, the pedestal 804 can have a generally circular cross-sectional shape (FIG. 11A), a generally elliptical shape (FIG. 11B), or a rectangular shape (FIG. 11C). Additionally, more than one pedestal 804 may be utilized in the boarding simulation device 108 (FIG. 11D). In some embodiments, the shape and size of the pedestal 804 may be selected based on criteria such as the desired stability or desired mechanical response of the pedestal 804 when under compression by the weight of the user.

In some embodiments, the mechanical response of the pedestal 804 may be influenced by the choice of material composition for the pedestal 804. These mechanical properties may include, but are not limited to, stiffness, elastic modulus, and relaxation modulus. For example, foam or foam-based materials having desired mechanical properties can be used to form the pedestal 804 so that when the user 806 leans into a given direction, the pedestal 804 can deform in that direction in a manner similar to the snow (for snowboarding) or the suspension (for skateboarding).

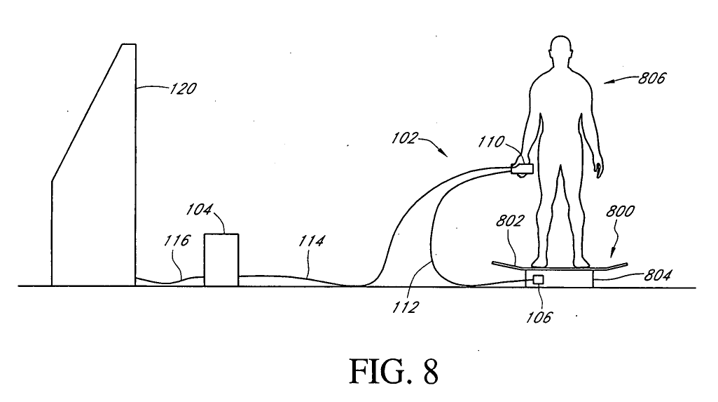

In some embodiments, it is not necessary for the pedestal 804 to adopt a block-type structure, as illustrated in FIG. 12A-12D. To simulate various motions on the boarding-sport simulation device 800, the pedestal 804 may include other structures or components that allow for generally restorative motions, such as tilts. In one embodiment, illustrated in FIG. 12A, the pedestal 804 may comprise more or more springs 1200. The position, number, and mechanical response of one or more of the springs 1200 may be varied as described above.

In another embodiment, illustrated in FIG. 12B, the pedestal 804 can be configured to make the boarding-sport simulation device 800 unstable. This instability provides greater maneuverability and challenge when using the boarding-sport simulation device 800. For example, a rounded member 1202, such as a hemisphere, can be used as a pedestal 804 so that the rounded surface 1208 of the member 1202 engages the floor 1204 at a contact point 1206.

In some applications, it may be desirable to moderate the degree of instability of the boarding-sport simulation device 800. For example, as shown in FIG. 12C, a dampening material 1210, such as foam, can cover the surface 1208 of the rounded member 1202 so that under weight and maneuvers, the dampening material 1210 can compress in a generally restorative manner. In another example, the rounded member 1202 can be formed from a reversibly compressible material, so that under weight, the rounded member 1202 can deform in a generally restorative manner.

In an alternative embodiment, illustrated in FIG. 12D, the pedestal 804 can further include a damper member 1212 positioned about the contact point 1206 so as to provide dampening of the rocking of the rounded member 1202. Such rocking can result from the tilting movements of the boarding-sport simulation device 800. In one embodiment, the rounded member 1202 can be a hemisphere. In one embodiment, the damper member 1212 can be a donut-shaped member that substantially surrounds the contact point 1206, thereby providing dampening functionality for tilts.

As shown and described herein, there are many different types and configuration of pedestals 804 that can support the board 802 so as to allow performance of various boarding maneuvers. Thus, the examples shown and described in reference to FIGS. 11A-11D and FIGS. 12A-12D should be understood as non-limiting examples.

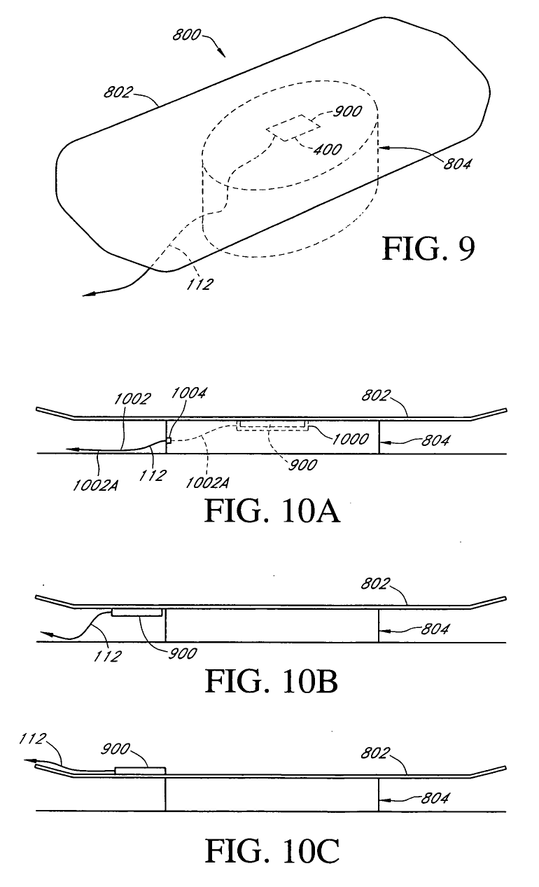

FIGS. 13 and 14 show that in some embodiments, the tilt sensor assembly 900 can be configured to detect tilts along two directions defined in a plane that is substantially co-planar with the board 802. For the purposes of description, a non-limiting example of a coordinate system 1300 is depicted in FIG. 13, where an X-direction 1302 can be transverse to the longitudinal axis of the board 802 and a Y-direction 1304 can be parallel to the longitudinal axis of the board 802.

Based on this coordinate system 1300, FIG. 14 illustrates that in one embodiment, the tilt sensor assembly 900 can include transverse and longitudinal tilt sensor components 1400 and 1402 that are respectively configured to detect X-direction 1302 and Y-direction 1304 components of a given tilt. The tilt sensor assembly 900 further includes the processor 402 to process sensing component signals 404 from such tilt sensor components 1400 and 1402 and output the simulation control signal 112. This simulation control signal 112 can provide one or more control functions to the game controller 110 for playing a boarding-sport game, as discussed above. In one embodiment, the tilt sensor components 1400 and 1402 may comprise one or more accelerometers that are configured to detect tilts along the X- and Y-directions 1302 and 1304.

In one embodiment, the tilt in the X-direction 1302 of the boarding-sport simulation device 800 can be used to control left and right turns in a game played on the gaming device 104. A user leaning left or right on the board 802 can effect a tilt having a transverse component which is detectable by the transverse tilt sensor component 1400. The resulting sensing component signal 404 output by the transverse tilt sensor component 1400 can be processed by the processor 402 to provide a simulation control signal 112 representative of the transverse tilt. When received by the game controller 110, this simulation control signal 112 may override the corresponding control function on the game controller 110, such as a left or right thumbstick motion. Thus, the transverse leaning motion of the user of the boarding-sport simulation device 800 results in a corresponding left or right turn in the game.

In one embodiment, a tilt in the Y-direction 1304 of the boarding-sport simulation device can be used to increase or decrease speed in a game played on the gaming device 104. A user leaning forward or backward on the board 802 can effect a tilt having a longitudinal (Y-direction) component which is detectable by the longitudinal tilt sensor component 1402. The resulting sensing component signal 404 output by the longitudinal tilt sensor 1402 can be processed by the processor 402 to provide a simulation control signal 112 representative of the longitudinal tilt. When received by the game controller 110, this simulation control signal 112 overrides the corresponding control function on the game controller 110, such as up or down thumbstick motion. Thus, the longitudinal leaning motion of the user of the boarding-sport simulation device 800 results in a corresponding increase or decrease in speed.

In one embodiment, combinations of longitudinal and transverse tilts may also be performed simultaneously on the boarding-sport simulation device 800 as described above to provide multiple game control functions. For example, a user may lean forward and to the right to effect a right turn while concurrently increasing speed in the game. It may be understood that alternative function control configurations for the boarding sport simulation device 800 are possible and that that those described above are non-limiting examples.

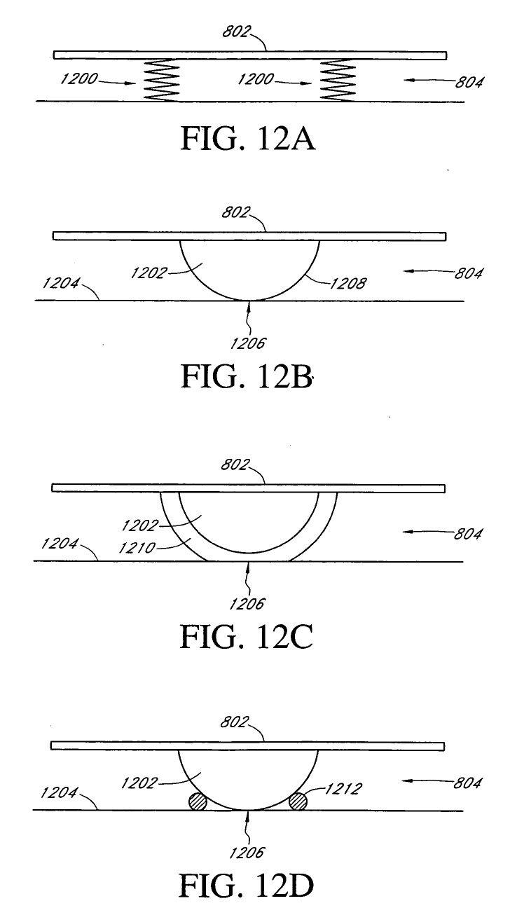

In some embodiments, the tilt sensor assembly 900 can also be configured to detect one or more motions other than or in addition to the X-direction 1302 and Y-direction 1304 tilts described above. For example, FIGS. 15 and 16 show that, in one embodiment, the tilt sensor assembly 900 can include one or more sensing components 400 configured to measure motion along three axes. In one embodiment, the sensing components 400 comprise a Freescale 3-axis +/−1.5 g accelerometer. In an alternative embodiment, tilt sensor assembly 900 may include a single semiconductor device configured to measure acceleration along the three axes. Signals from the sensing components 400 of the tilt sensor assembly 900 can be processed by the processor 402 and output as the simulation control signal 112 in a manner similar to that described above in reference to FIGS. 13-14.

In one embodiment, the tilt sensor assembly 900 measures tilts in the X-direction 1302 and Y-direction 1304, as described above, as well as motions along a Z-direction 1500. The Z-direction 1500 extends generally perpendicular to the plane defined by the X- and Y-directions 1302 and 1304, as illustrated in FIG. 15. In one embodiment, the Z-direction 1500 motion of the boarding-sport simulation device 800 can simulate board maneuvers such as hopping.

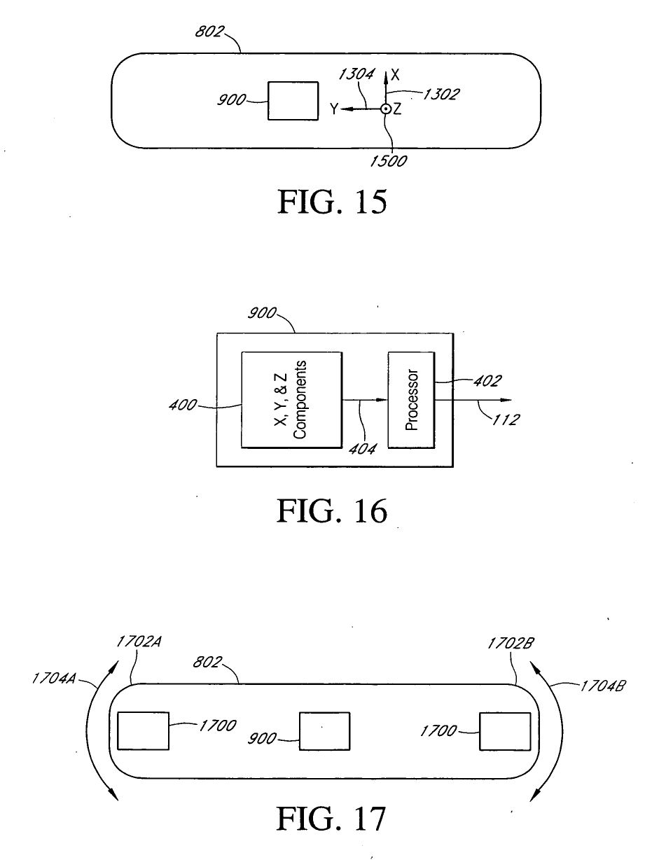

FIG. 17 shows that in some embodiments, the system can detect additional boarding maneuvers for use as control functions 300′ for a game. As is generally known, either end of the board 802, such as a skateboard or snowboard, can be swung to perform maneuvers such as turning or sliding. To accommodate simulation of such end-motion maneuvers, the interface system 102 may further comprise one or more end-swing sensor components 1700. The end-swing sensor components 1700 may be positioned at a front-end 1702A or a rear-end 1702B of the boarding sport simulation device 800 to detect swinging or rotational motions, depicted as arrows 1704A and 1704B, respectively. Thus, the end-swing sensor component 1700 positioned at the front end 1702A of the board 802 can detect swinging or rotational motions 1704A at the front end 1702A of the board 802. Similarly, the end swing sensor component 1700 positioned at the rear end 1702B of the board 802 can detect swinging or rotational motion at the rear-end 1702B of the board 802.

As further shown in FIG. 17, the boarding-sport simulation device 800 can utilize a plurality of the end-swing sensor components 1700. In one embodiment, such end-swing sensor components 1700 can be used in conjunction with the tilt sensor assembly 900 configured to operate as described above in reference to FIGS. 13-16 to detect tilts. In one embodiment, sensing component signals 404 from the end-swing sensors 1700A and 1700B can be processed by the processor 402 in the manner described above in reference to FIGS. 13-16.

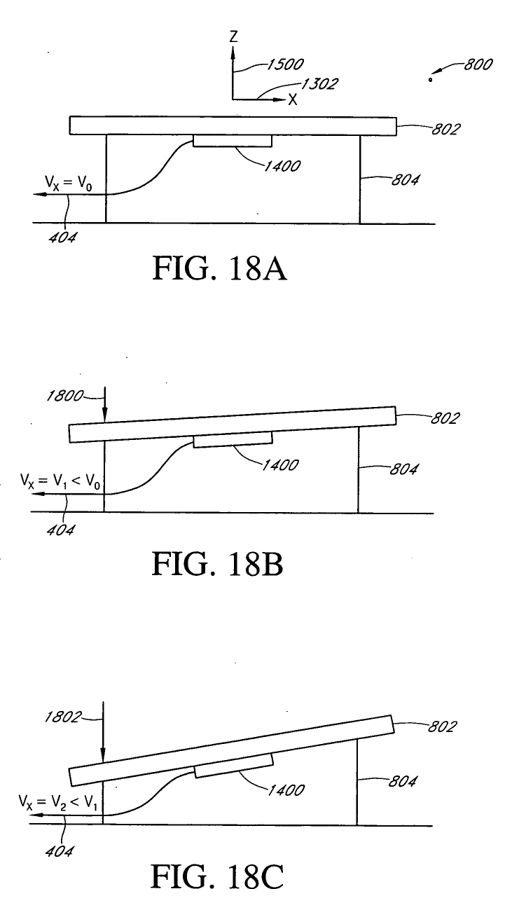

FIGS. 18A-18C show an example of how a tilt can be detected by the transverse tilt sensor 1400 of the tilt assembly 900 so as to produce sensing component signals 404 representative of the tilt. FIG. 18A shows one embodiment of the boarding-sport simulation device 800 when the user (not shown) is not leaning to any side. In such a riding position, the sensing component signal 404 output by the transverse tilt sensor 106 may comprise a voltage signal Vₓ indicative of the transverse tilt which can be set at V₀.

In FIG. 18B, the boarding-sport simulation device 800 is shown when the user leans on the left side of the boarding-sport simulation device 800 (depicted as an arrow 1800), thereby compressing the left side of the pedestal 804. Such a tilt to the left can be detected by the transverse tilt sensor 1400, which generates a sensing component signal 404 comprising a voltage signal Vₓ=V₁. In this example, the tilt is depicted as being in the negative X-direction and, in one embodiment, the voltage assigned to such a movement can be assigned a voltage that is more negative than the “no-lean” voltage V₀.

In FIG. 18C, the user is shown to lean even more on the left side, as depicted in an arrow 1802. Such a tilt can be detected by the transverse tilt sensor 1400, which generates a sensing component signal 404 comprising a voltage signal Vₓ=V₂, which is more negative than V₁.

In further embodiments, motion in the Y- and Z-directions 1304 and 1500 may be similarly configured. For example, the degree of motion in the Y- and Z-directions 1304 and 1500 may be detected and result in a sensing component signal 404 comprising a DC voltage whose magnitude depends on the amount of tilt and whose sign (positive or negative) depends on the direction of the tilt. It will be understood that alternative voltage assignments for a given degree and direction of tilt may also be utilized.

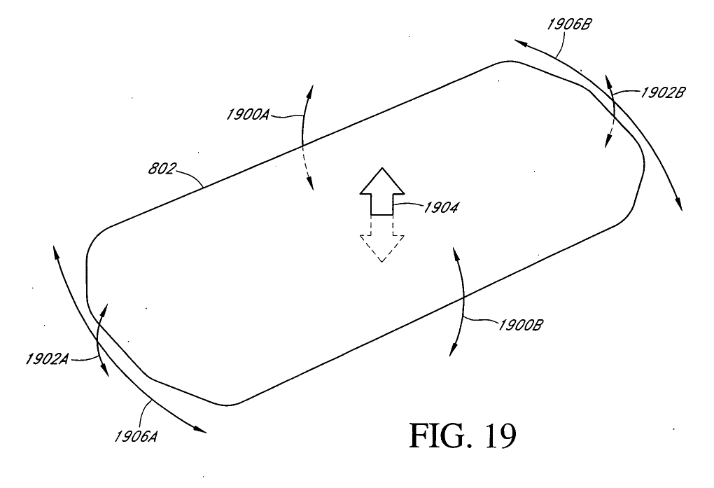

FIG. 19 shows non-limiting examples of boarding maneuvers that can be detected and used as control functions for a game using the various techniques disclosed herein. Such board motions may include, but are not limited to, side tilts 1900A and 1900B, end tilts 1902A and 1902B, vertical motions 1904 (such as hopping), and end swings 1906A and 1906B.

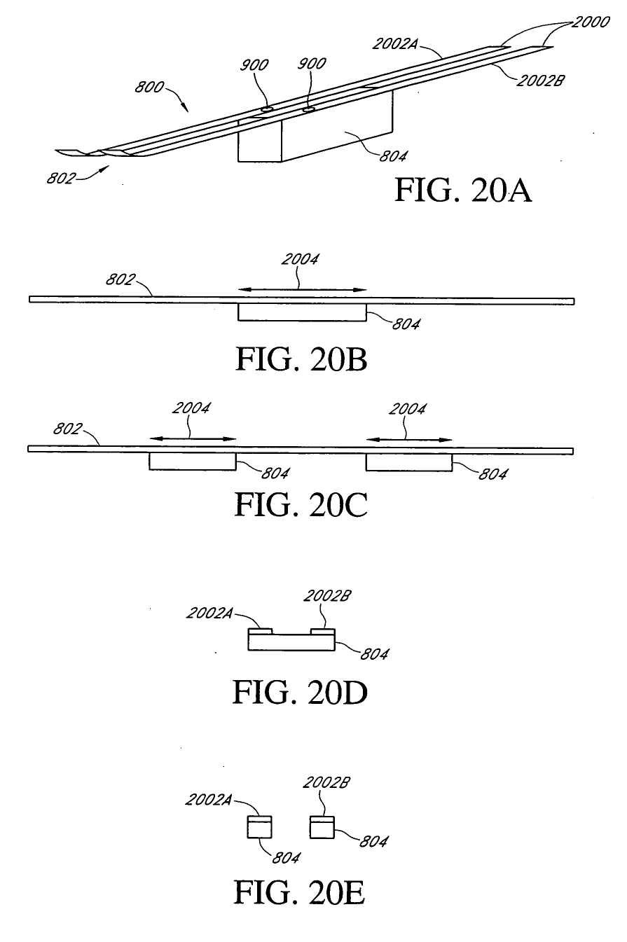

FIGS. 20A-20E show that the various features of the embodiments of the present invention can also be applied for simulation of sports such as skiing. The board 802 of the boarding-sport simulation device 800 may comprise skis 2000. The skis 2000 may have a single slat or two or more slats 2002A and 2002B. For skis 2000 possessing a single slat, various motion simulations can be achieved in a manner similar to that described above in reference to FIGS. 1-19.

In one embodiment, the skis include two slats 2002A and 2002B. For example, the two slats 2002A and 2002B can be collectively referred to as the board 802. In the embodiment of FIG. 20, each of the slats 2002A and 2002B is shown to have its own tilt sensor assembly 900. In one embodiment, one or more tilt sensor assemblies 900 can be positioned on a given ski 2000 and used in a manner similar to that described above in reference to FIGS. 1-19.

As shown in the embodiment of FIG. 20A-20E, the two slats 2002A and 2002B can be positioned on various configurations of the pedestal 804. In non-limiting examples, FIGS. 20B and 20C show that the pedestal 804 can cover one section 2004 (FIG. 20B) along the longitudinal direction of the slats 2002A and 2002B or more than one section 2004 (FIG. 20C). Also, in a non-limiting example, FIG. 20D shows that a given pedestal 804 can cover both slats 2002A and 2002B. In a further non-limiting example, FIG. 20E shows that each of the slats 2002A and 2002B can be supported by a separate pedestal 804. Alternative configurations are also possible.

In one embodiment, the example pedestals 804 of FIGS. 20A-20E can be configured in a manner similar to that described above with reference to FIGS. 1-19.

Although the above-disclosed embodiments have shown, described, and pointed out the fundamental novel features of the invention as applied to the above-disclosed embodiments, it should be understood that various omissions, substitutions, and changes in the form of the detail of the devices, systems, and/or methods shown may be made by those skilled in the art without departing from the scope of the invention. Consequently, the scope of the invention should not be limited to the foregoing description.

What is claimed is:

1. A system for interfacing an exercise device with a gaming device capable of playing video games, comprising:
at least one sensor positioned adjacent to a moving portion of the exercise device, wherein the at least one sensor measures at least one motion parameter of the exercise device and generates at least one simulation control signal providing a first plurality of control functions for the gaming device representative of the at least one motion parameter; and
at least one video game controller housing a plurality of user-actuated controls capable of single- and multi-dimensional actuation, wherein actuation of the controls by a user provides a second plurality of control functions for the gaming device and wherein the video game controller communicates with the at least one sensor to receive the at least one simulation control signal;
and wherein the at least one video game controller outputs a third plurality of control functions for the gaming device comprising at least one of the first and second plurality of control functions.

2. The system of claim 1, wherein at least one of the first plurality of control functions overrides at least one of the second plurality of control functions.

3. The system of claim 2, wherein the second plurality of control functions are not overridden by the first plurality of control functions when the sensor is not in communication with the at least one video game controller.

4. The system of claim 2, wherein the video game controller overrides two of the second plurality of control functions provided by two-dimensional actuation of the video game controller with two of the first plurality of control functions.

5. The system of claim 4, wherein two-dimensional actuation of the video game controller comprises simultaneous movements of the plurality of controls selected from the group consisting of up, down, left, and right movements.

6. The system of claim 4, wherein the simulation device comprises a boarding sport simulator.

7. The system of claim 4, wherein the at least one motion parameter comprises tilting.

8. The system of claim 1, wherein the exercise device comprises a bicycle.

9. The system of claim 1, wherein the at least one motion parameter comprises speed.

10. The system of claim 1, wherein the at least one simulation control signal is user scalable.

11. The system of claim 1, wherein the controls of the video game controller are selected from the group consisting of buttons, triggers, thumbsticks, and directional pads.

12. The system of claim 1, wherein the gaming device comprises a video game console selected from the group consisting of Sony Playstation™ video game consoles, Sony Playstation 2™ video game consoles, Sony Playstation 3™ video game consoles, Nintendo GameCube™ video game consoles, Microsoft XBox™ video game consoles, and Microsoft Xbox 360™ video game consoles.

13. A system for interfacing a simulation device with a gaming device capable of playing a video game, comprising:
a simulation device which allows a user to perform a plurality of movements simulating a physical activity;
at least one sensor positioned adjacent to a moving portion of the simulation device, wherein the at least one sensor measures at least one motion parameter of the exercise device and generates at least one simulation control signal providing a first plurality of control functions for the gaming device representative of the at least one motion parameter; and
at least one video game controller housing a plurality of controls capable of single- and multi-dimensional actuation, wherein user actuation of the controls provides a second plurality of control functions for the gaming device and wherein the video game controller receives the at least one simulation control signal.

14. The system of claim 13, wherein the video game controller overrides two or more of the second plurality of control functions provided by two-dimensional actuation of the video game controller with two or more of the first plurality of control functions.

15. The system of claim 14, wherein two-dimensional actuation of the video game controller comprises simultaneous movements of the plurality of controls selected from the group consisting of up, down, left, right, and depressive movements.

16. The system of claim 14, wherein the simulation device comprises a boarding sport simulator

17. The system of claim 14, wherein the plurality of movements comprises tilting.

18. The system of claim 13, wherein the simulation device comprises an exercise bicycle.

19. The system of claim 13, wherein the at least one motion parameter comprises speed.

20. The system of claim 13, wherein the gaming device comprises a video game console selected from the group consisting of Sony Playstation™ video game consoles, Sony Playstation 2™ video game consoles, Sony Playstation 3™ video game consoles, Nintendo GameCube™ video game consoles, Microsoft XBox™ video game consoles, and Microsoft Xbox 360™ video game consoles.

21. A system for interfacing a simulation device with a gaming device capable of playing video games, comprising:
at least one sensor which measures at least one simulation parameter of the simulation device and generates at least one simulation control signal providing a first plurality of control functions for the gaming device representative of the at least one simulation parameter; and
at least one video game controller housing a plurality of controls capable of single- and multi-dimensional actuation, wherein actuation of the controls by a user provides a second plurality of control functions for the gaming device, and wherein the at least one video game controller receives the first plurality of control functions from the sensor;
and wherein the at least one video game controller overrides at least one of the second plurality of control functions with at least one of the first plurality of control functions and outputs a third plurality of control functions comprising at least one of the control functions of the first and second plurality of control functions.

22. The system of claim 21, wherein the system further comprises a switch that allows the user to select at least one control function from the first plurality of control functions which overrides the at least one control function of the second plurality of control functions.

23. The system of claim 21, wherein the second plurality of control functions are not overridden by first plurality control functions when the sensor is not in communication with the at least one video game controller.

24. The system of claim 21, wherein the simulation control signal is user scalable.

25. The system of claim 21, wherein the video game controller overrides two of the second plurality of control functions provided by two-dimensional actuation of the video game controller with two of the first plurality of control functions.

26. The system of claim 25, wherein two-dimensional actuation of the video game controller comprises simultaneous movements of the plurality of controls selected from the group consisting of up, down, left, and right movements.

27. The system of claim 25, wherein the simulation device comprises a boarding sport simulator.

28. The system of claim 21, wherein the simulation device comprises an exercise device.

29. The system of claim 28, wherein the simulation device comprises a bicycle.

30. The system of claim 21, wherein the simulation parameter comprises a motion parameter of a moving portion of the simulation device actuated by the user selected from the group consisting of speed, r.p.m., distance, tilt, rotation, and vertical movement.

31. The system of claim 21, wherein the gaming device comprises a video game console selected from the group consisting of Sony Playstation™ video game consoles, Sony Playstation 2™ video game consoles, Sony Playstation 3™ video game consoles, Nintendo GameCube™ video game consoles, Microsoft XBox™ video game consoles, and Microsoft Xbox 360™ video game consoles.

32. The system of claim 21, wherein the controls of the video game controller are selected from the group consisting of buttons, triggers, thumbsticks, and directional pads.
